(19) United States
(12) Patent Application Publication
(10) Pub. No.: US 2013/0074765 A1
(43) Pub. Date: Mar. 28, 2013

(54) METHOD OF ADJUSTING SURFACE TOPOGRAPHY

(71) Applicants: Philip Heylen, Cambridge (GB); Nicholas Campbell, Cambridge (GB)

(72) Inventors: Philip Heylen, Cambridge (GB); Nicholas Campbell, Cambridge (GB)

(73) Assignee: INCA DIGITAL PRINTERS LIMITED, Cambridge, Cambridgeshire (GB)

(21) Appl. No.: 13/700,238

(22) PCT Filed: May 27, 2011
(86) PCT No.: PCT/GB2011/051012

§ 371 Date: Dec. 6, 2012

(30) Foreign Application Priority Data
May 27, 2010 (GB) 1008891.2

(51) Int. Cl. B05D 5/00; B05C 5/00

(52) U.S. Cl. CPC B05D 5/00; B05C 5/00
USPC 118/323; 427/8

(57) ABSTRACT

Methods for adjusting the topography of a surface, such as for making a support surface substantially flat, e.g. for mitigating variations in a print gap, are described. The topography of the surface is first measured, and then a shim layer is printed to approximate the topography to a reference topography, the thickness of the layer being calculated using the measurements. For example the print gap comprising the distance between the surface of a printer table and printing means, such as a printhead. The print gap is first measured before at least one layer of ink is printed, using the printing means, at a selected position based on the measured print gap. The thickness of the layer of ink is selected to mitigate the variations in the print gap. In some embodiments, a substrate support surface may then be arranged over the printer table, so that the printed layer is disposed between the printer table and the substrate support surface. The apparatus can compensate for variations in the print gap due both to irregularities in the printer table surface and misalignment in mounting of the printing means. Also described is a printer table produced according to the methods described.

This invention relates to a method of adjusting the topography of a surface. In particular, the method is useful in machines which have a work head arranged to move over a work piece mounted on a support surface, such as a machine for coating a sheet material, or a machine for inspecting a substantially planar surface. In such machines it is preferable that the surface of the work piece is a uniform distance from the work head over the work area. This helps to ensure, for example, that the coating is of a uniform thickness, or that the work head is focussed correctly on the work piece as it moves over it.

For example, in the production of flat panel displays, a slit coater may be used to apply a resist layer to a glass substrate. The slit coater is a long straight bar with pressurised resist material being squeezed out of the gap between the slit and the substrate, the bar sliding across the substrate to make a thin layer of resist. The gap is critical to achieve good uniformity of the coating. Thus the table is usually made with heavy granite or similar material, although lighter materials such as aluminium, carbon fibre or thin ceramic materials could potentially be used.

Furthermore flat panel displays are frequently treated with a laser. The laser exposure head is normally equipped with autofocus, but it is preferable for the gap between the head and the panel to remain substantially constant. This enables the search region of the autofocus to be narrower, giving a better quality result. Also the process may be carried out more quickly and efficiently. Focussed lasers and focussed imaging devices are also used in other applications such as printed circuit board inspection and repair systems, and direct exposure of semiconductors. In such systems an accuracy of between 50 and 100 microns is often required. A typical focus depth is 50 microns. The workpiece is typically around 1 mm thick. The thickness of the printed circuit board may be measured before the inspection is carried out so as to set the focal length. However, variations in the table topography will mean that it is necessary to vary the focal length. It would be simpler and quicker if this were not necessary.

Such machines may be large, requiring a large rigid support surface or table. For example, in flat panel displays, the resist layer may be applied to a large glass substrate, which is then cut up into several display panels. In PCB inspection, a typical table size is 750 mm×750 mm. Because the surface must be rigid, it may also be thick and heavy. It is difficult in practice to make such large surfaces perfectly flat, and/or to ensure that the gap between the support surface and the work head is perfectly uniform.

Similarly, in a machine such as an ink jet printer, the print quality is strongly influenced by the gap between the printheads and the substrate surface. As droplets get smaller, to increase the print resolution, this print gap needs to reduce, and becomes more critical. It is important not only to maintain a small print gap, but to keep it uniform, otherwise print quality will vary over the print area. Print gaps on large inkjet printers are typically around 1.5 mm. Building a large machine (e.g. 3.2 m by 1.6 m print zone) with tight tolerances on the print gap is technically difficult and expensive.

Variations in the print gap can arise both from irregularities in the surface supporting the substrate and from a lack of alignment of the carriage and other support structures supporting the printhead as it moves over the substrate surface. For example, the substrate support surface may be uneven or may sag or bow in certain areas. Further, the plane of movement of the printer carriage may not be exactly parallel to the plane of the substrate support surface, resulting in a larger print gap at one side of the printer table than the other.

Previous systems and methods have focussed on minimising these irregularities and addressing the installation issues. For example, a substrate support surface is designed to be as flat as possible and errors in alignment of the work head, such as the printhead, are minimised. However, it has been found that, even in an accurate installation, the variation in the gap can still be of the order of 1 mm. In a printer, such a variation in the print gap can result in visible print artefacts, particularly in a high resolution print.

A further approach has been to adjust the timing of firing of the printer nozzle to accommodate for variations in the print gap. This can assist particularly for systemic issues (such as axis alignment problems), but it is difficult to accommodate for smaller variations in the print gap, for example due to sagging of the substrate support surface. Further, the measurements and timing adjustments required can slow printing and firing timing alone is insufficient to compensate for large variations in the print gap.

The present invention aims to provide a method of mitigating these problems.

According to the present invention, there is provided a method of approximating the topography of a surface to a required topography, the method comprising: taking measurements representative of the topography of the surface; determining the thickness profile of a shim layer to approximate the topography of the surface to the required topography based on the measurements; and applying the shim layer to the surface; the shim layer being provided by printing the shim layer from a print head.

This is a simple and accurate method of adjusting the topography of a support surface, for example to make the surface substantially flat.

The shim layer may be printed directly onto the surface, either by mounting a print head over the surface, or by moving the surface to a print head in a print area. In the former case for example, a print head may be mounted adjacent a work head; eg an ink jet device could be mounted near a laser exposure head.

In some applications, an overlayer is placed on the surface to provide a working surface, in which case the shim layer may alternatively be printed onto the overlayer by a printer located remotely from the work surface. The overlayer may be placed with the printed shim layer uppermost, or the other way up with the shim layer located between the overlayer and the surface. The required topography may be a flat surface, such that the thickness of the shim layer is selected to mitigate variations in the measured topography.

Alternatively the required topography may be a topography in which the distance between the surface and a reference point is constant. For example, the gap between the surface and the work head may be required to be substantially constant. In such cases, the measurements representative of the topography of the surface may comprise the distance at a plurality of positions between the surface and a reference point. For example, in a machine having a workhead mounted over the surface, such as where the surface is a support surface for a workpiece, the reference point may be the position of the workhead. Where the workhead moves over the surface, the reference point in each of the plurality of positions will be a point lying in the plane of movement of the workhead. This is advantageous in many applications, as described above, such as where the workhead is the printhead, to increase print quality by maintaining a constant print gap.

For example where the method is used in a machine using a lens for focussing, the required topography is chosen such that the distance between the reference point and the surface is the focal distance of the lens, taking into account the thickness of the work piece. This may apply to a device for inspecting the work piece, or a device for applying a process to the work piece such as a focussed laser.

Conveniently, the measurements are taken using a sensor mounted on or adjacent the workhead. This gives a direct measurement of the gap. It may also be possible to use the autofocussing system to provide the required measurements. This has the advantage of using the property we wish to minimise, and also of not requiring an additional sensor.

Where the method is used in a machine for applying a coating to the work piece for example, the topography of the surface can be determined by measuring the thickness of a coating applied by the machine rather than by direct measurement of the distance between the work piece and the work head. For example the work head may be a slit coater. This may enable other factors that may affect the uniformity of the coating to be taken into account, such as variations in the straightness or width of the slit.

In some embodiments, ink may be used to print the shim layer. The ink used to print the shim layer may be UV-curable free radical ink. In a printer, the ink may be the same ink used for printing on a substrate. Hence a single printhead may be used both to reduce variations in the print gap and to print images onto substrates without requiring modifications to the printhead or the fluid used for printing.

In other embodiments, a separate printhead and/or a different printing fluid may be used to form the shim layer. In particular, the shim layer may be formed using epoxy resin, acrylic resin or a filler in solvent. The shim layer may advantageously be formed by any substance, in particular a fluid or liquid, that can be transformed to a solid phase by irradiant rays (for example UltraViolet, visible, InfraRed or Electron Beam radiation), heat, chemical reaction, or a solvent. The layer is preferably laid down by a printhead, but any suitable mechanism that is controllable to deposit a thin layer of the relevant substance may be used.

Advantageously, in embodiments described herein, measurements of the topography of the surface, and/or the thickness of the required shim may be taken when the machine is on site and in situ, so any features of the topography resulting from the situation or arrangement of the machine (for example, due to an uneven floor surface) can be taken into account in preparing the shim. Further, measurements of the surface topography can be taken at any time during the life of the machine, so onsite recalibration is possible.

The method may equally be applied to other fields of technology. The advantages of applying the techniques described herein to other fields will be clear to those skilled in the art.

According to another aspect, there is provided a method of mitigating variations in a print gap, the print gap comprising the distance between the surface of a printer table and printing means, the method comprising:
measuring a print gap; and
printing, using the printing means, at least one layer of ink having a thickness selected to mitigate the variation at a selected position based on the measured print gap.

The method may enable the printer table to be rendered substantially smooth within a smaller variation than was previously possible. By measuring using the printers own axes, errors in print gap due to axis errors are taken into account as well as table flatness errors.

In a preferred embodiment, the method further comprises providing a substrate support surface separate from the printer table and arranging the substrate support surface on the printer table after the at least one layer has been printed, wherein the substrate support surface is arranged so that the at least one layer is disposed between the substrate support surface and the printer table. That is, the layer is arranged to support the substrate support surface on the printer table.

Preferably, the substrate support surface comprises a thin metallic sheet, preferably an aluminium sheet having a thickness of around 1 mm.

In one embodiment, the at least one layer of ink is printed on the surface of the printer table. In this embodiment, the print gap may be measured and printed layer(s) applied directly to mitigate variations detected in the measuring step.

In an alternative embodiment, the at least one layer of ink is printed on the substrate support surface. In this case, the print gap may be measured over the whole or part of a printing area, and the printed layer(s) may be applied in a separate step to the lower surface of the substrate support surface. The printing step is preferably performed by the same printer as that at which the gap was measured, but the printed layer may be applied to the substrate support surface using separate printing apparatus.

In a highly preferred embodiment, measuring the print gap comprises providing a sensor at the printing means to measure the distance to the printer table, preferably wherein the sensor comprises a laser sensor or an inductive sensor. Mounting a sensor at the printing means, for example at the printhead or on the carriage that carries the printhead, can enable the actual print gap to be determined with greater accuracy. In particular, variations in the print gap over the printing area due to factors other than the smoothness of the printing table (for example due to misalignment of the print axes or problems with installation of the frame) are automatically taken into account, in addition to those caused by variations in topography of the surface itself.

In an alternative embodiment, measuring the print gap may comprise other techniques for measuring the topology of the printer table including using imaging techniques to make a 3-dimensional image of the surface of the printer table

Preferably, measuring the print gap further comprises moving the printing means across a printing area of the printer table and measuring the print gap across the printing area using the sensor. That is, the printing means may be scanned across the printing area, which is usually smaller than the physical dimensions of the printer table, to enable measurements to be taken. Advantageously, elements of the apparatus used for printing, such as the printhead carriage, belts and motor, can be used to scan the printing means, and hence the sensor, over the printing area.

In some embodiments, measuring the print gap comprises placing a covering sheet over the printer table and measuring the distance from the printing means to the covering sheet, preferably wherein the covering sheet comprises a metallic sheet. This may be useful, for example if the sensor is an inductive sensor which requires a conductive surface to determine measurements. The covering sheet may be the substrate support surface.

Preferably, the method includes printing one or more layers of ink at the selected position to reduce the print gap to a predetermined distance. The selected position may comprise the position at which the distance measurement is currently being taken. Alternatively, distance measurements may be recorded and stored together with an indicator of the position on the printing table, or within the printing area, that the measurement has been taken. These stored measurements may then be used to create printed layers of an appropriate height to compensate for variations in the print gap.

In one embodiment, the predetermined distance comprises the minimum print gap measured between the printing means and the printer table. That is, the print gap at all points in the printing area may be reduced to the minimum measured gap.

Preferably, the predetermined distance is constant over a printing area of the printer table.

In a preferred embodiment, the print gap is reduced to a predetermined distance with a variation of less than 1 mm, preferably less than 0.5 mm, preferably around 0.1 mm. Hence a greater degree of accuracy in the smoothness of the printing surface can be achieved than has previously been possible.

In a highly preferred embodiment, the layer of ink comprises a discontinuous layer comprising a plurality of spaced apart portions. For example, the layer may comprise a plurality of discrete spacers. Each spacer comprises one or more layers of ink which are built up on top of each other. The spacer is preferably in the shape of a lozenge or pill, but may be circular, rectangular, or comprise any convenient shape. Alternatively, the spacers may be of different shapes and surface areas depending on the requirements for reducing variations in the print gap.

Preferably, the spaced apart portions comprise a plurality of spacers, each having a surface area with a diameter of less than 20 mm, preferably around 10 mm.

In a preferred embodiment, a plurality of spacers are printed in a grid pattern. The grid of spacers supports the substrate support surface to keep the topography of the surface planar by accommodating for variations in the topography of the printer table and variations caused by the installation of the printing apparatus.

In a preferred embodiment, the grid pattern has a grid spacing of less than 30 mm, preferably around 15 mm. It has been found that, together with a spacer diameter of around 10 mm, a grid of spacers at this density can support the substrate support surface without resulting in sagging between the spacers.

Preferably, vacuum holes are provided in the printer table and the substrate support surface. The vacuum holes enable a negative pressure to be applied to a substrate on the substrate support surface to securely hold the substrate to the surface. The pattern of holes in the printer table may be different to that in the substrate support surface. For example, a denser array of smaller holes may be provided in the substrate support surface.

In a highly preferred embodiment, the plurality of spacers are arranged to avoid obstructing the vacuum holes in the printer table and the substrate support surface.

Preferably, a border is printed around the edges of the grid of printed spacers to reduce the loss of vacuum pressure between the printer table and the substrate support surface. The border may be continuous, but is preferably printed to be the same height as nearby spacers to maintain the flatness of the substrate support surface on the printer table. In some areas, therefore, where there are no spacers and the substrate support surface lies directly on the printer table, it may not be necessary to print a border.

According to a further aspect, there is provided a printing apparatus comprising:
at least one printing means;
a printer table;
means for measuring a print gap between the printing means and the printer table;
means for controlling the printing means to print at least one layer of ink of controllable thickness at a selected position based on the measured print gap.

Preferably, the apparatus further comprises a substrate support surface. The substrate support surface may be disposed on the printer table with the at least one layer of ink therebetween.

Preferably, the means for measuring the print gap comprises a sensor mounted to the printing means. In one embodiment, the sensor comprises an inductive sensor. In an alternative embodiment, the sensor comprises a laser sensor. A laser sensor may enable the height and dimensions of the at least one layer of ink to be determined after printing to ensure that it correctly compensates for variations in the print gap.

According to a further aspect, there is provided a printer table for supporting a substrate relative to a printhead of a printer, the table comprising:
a printer table surface;
a substrate support surface disposed on the printer table surface; and
a shim layer disposed between the printer table surface and the substrate support surface, the shim comprising at least one layer of printed ink and arranged to support the substrate support surface as a substantially planar surface.

In a preferred embodiment, supporting the substrate support surface as a substantially planar surface comprises supporting the substrate support surface to maintain a substantially constant distance between the substrate support surface and the printhead.

Preferably, the variation in the substrate support surface from the plane is less than 1 mm, preferably less than 0.5 mm, preferably less than 0.1 mm.

In a highly preferred embodiment, the shim comprises a plurality of spacers, preferably wherein each spacer has a diameter of less than 20 mm, preferably around 10 mm.

Preferably, the spacers are arranged in a grid pattern, preferably to avoid obstructing vacuum holes in the printer table and the substrate support surface.

In one embodiment, the substrate support surface comprises a thin sheet of a metallic material, preferably having a thickness of around 1 mm, the sheet preferably comprising aluminium.

According to a further aspect, there is provided method of mitigating variations in the topography of a surface, the method comprising:
measuring the surface topography;
printing from the printhead at least one layer of ink at a selected position based on the measured topography, the layer thickness being selected to mitigate variations in the surface topography.

As noted above, while the present method may be particularly applicable to providing a surface for printing, the same method may also be used for other surfaces. For example, methods described herein may be used to provide a flat surface for a microscope or other precision instrumentation, in which case the printhead may be suspended above the surface, preferably on the same support structure that is used to move the microscope over the surface.

Preferably, mitigating variations in the topography of the surface comprises increasing the smoothness of the surface.

Preferably, mitigating variations in the topography of the surface comprises minimising variations in a measured distance between a reference point and the surface.

In a preferred embodiment, mitigating variations in the topography of the surface comprises minimising variations in the measured distance between a reference point and the surface. Preferably, the reference point comprises the position of the printhead. This may incorporate both increasing the smoothness or flatness of the surface and compensating for any variations in the height at which the printhead is mounted over the surface.

According to a further aspect, there is provided a method of approximating the topography of a surface to a reference topography, the method comprising:
measuring the surface topography;
printing from the printhead a shim layer to approximate the topography of the surface to the reference topography;
providing an overlayer over the shim layer to provide a working surface over the surface.

Preferably, measuring the surface topography comprises measuring the distance between the surface and a printhead mounted over the surface at a plurality of points.

The reference topography preferably comprises a substantially flat or planar surface. However, the reference topography may incorporate some variations from the planar surface to take into account factors such as the variations in the height at which the printhead is mounted over the surface. As described above, the shim layer, which may comprise a plurality of discrete spacers, may be printed on the surface itself or on the underside of the overlayer.

In a further embodiment, the reference topography may be varied depending on article that is to be placed on the surface to be printed. By way of example, if the article is a wedge-shaped 3-D object, that is thicker at one end than the other, the shim layer may be printed to provide a compensating wedge in the opposite direction so that the surface of the object is maintained at a constant distance from the printhead.

As noted above, the working layer may be a layer onto which a substrate may be placed for printed. Alternatively, the working layer could provide a surface for another instrument such as a microscope.

The invention extends to methods and/or apparatus substantially as herein described with reference to the accompanying drawings. The invention also extends to a printer table, a surface or a shim layer produced using the methods described herein and to printed products produced using the methods and apparatus described herein.

Any feature in one aspect of the invention may be applied to other aspects of the invention, in any appropriate combination. In particular, method features may be applied to apparatus aspects and vice versa.

Embodiments of the invention are described below with reference to the drawings in which:

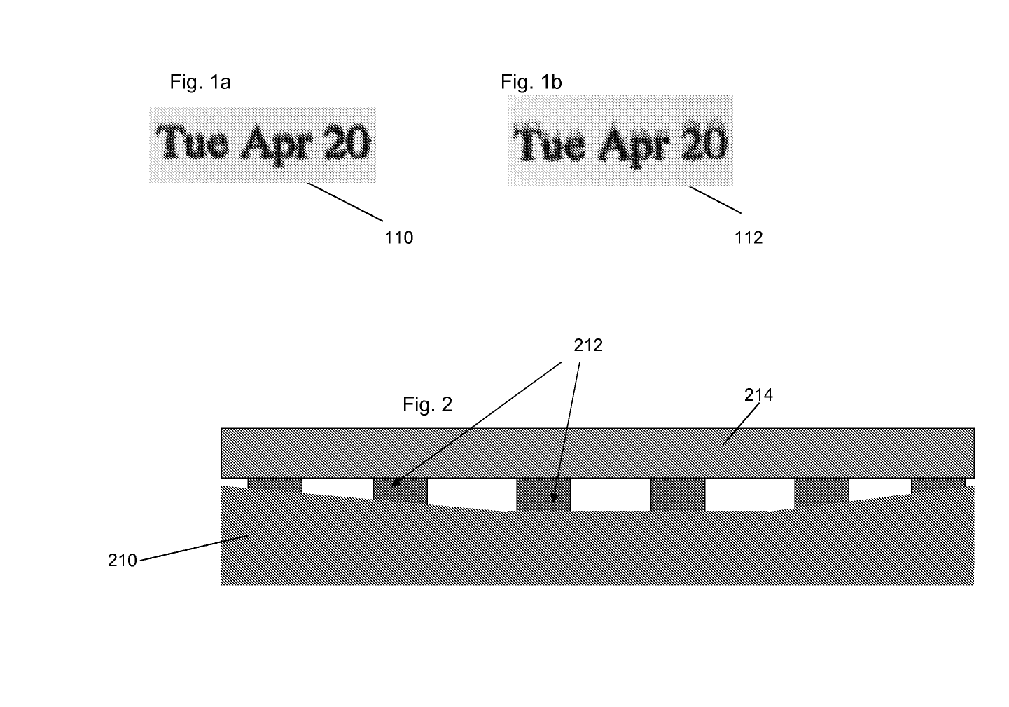

FIGS. 1a and 1b are a schematic illustration of print artefacts that may arise due to a variation in the print gap;

FIG. 2 is a schematic diagram of a printer table according to one embodiment;

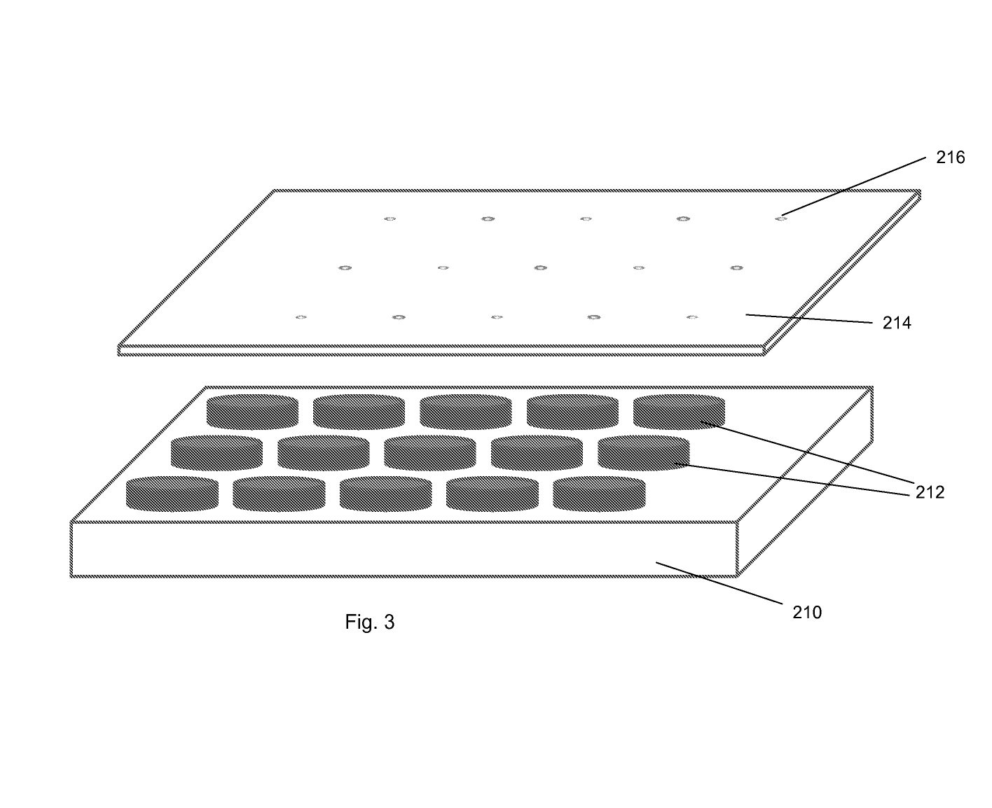

FIG. 3 is a further, expanded view of the printer table illustrated in FIG. 2;

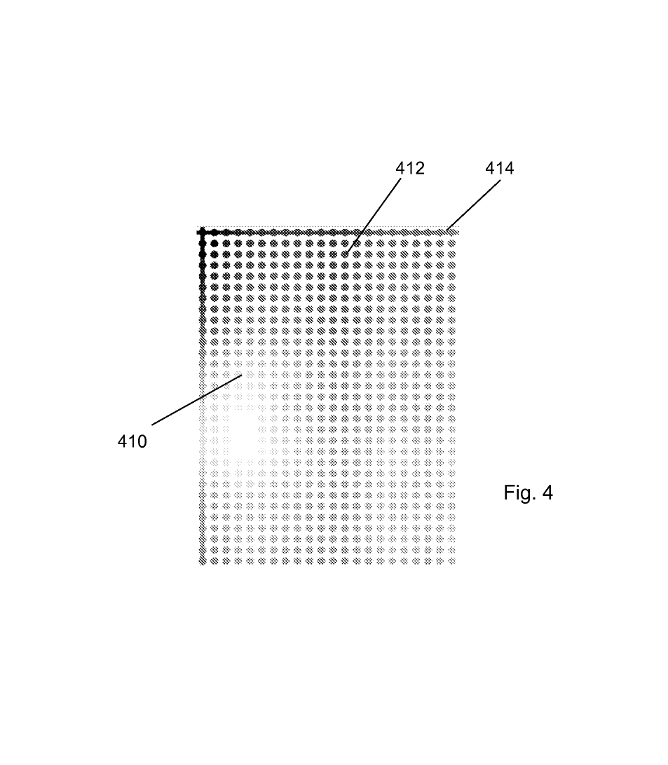

FIG. 4 illustrates a plurality of printed shims according to one embodiment;

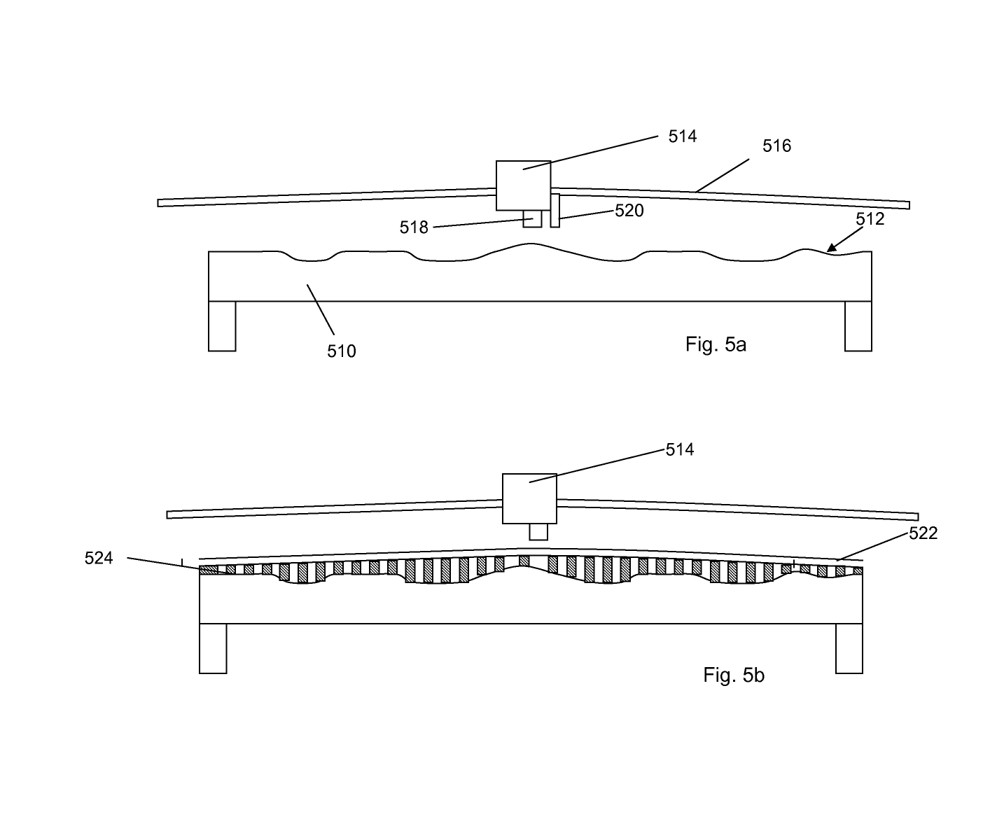

FIG. 5a is a schematic diagram of a printer in sensing mode according to one embodiment;

FIG. 5b is a schematic diagram of a printer with an adjusted substrate surface according to one embodiment;

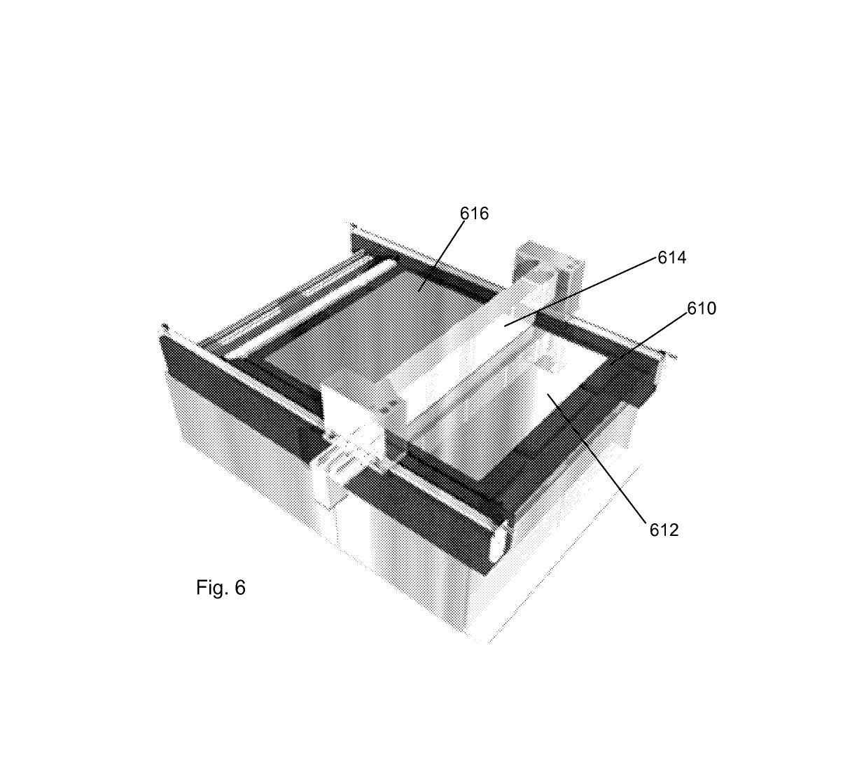

FIG. 6 illustrates a slit coater according to one embodiment;

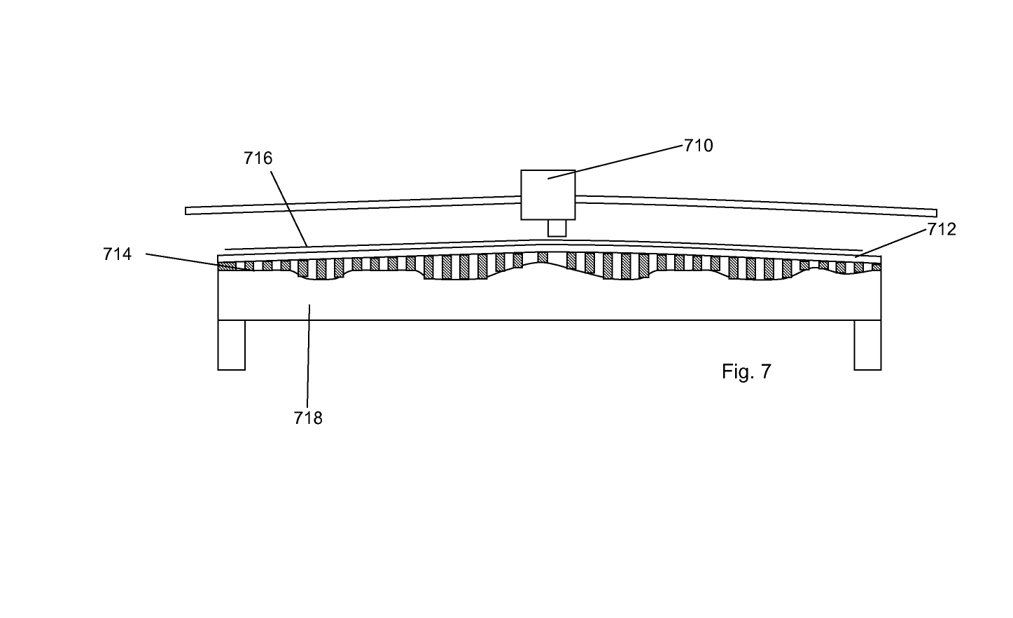

FIG. 7 is a schematic diagram of a photo-resist lasering system according to one embodiment;

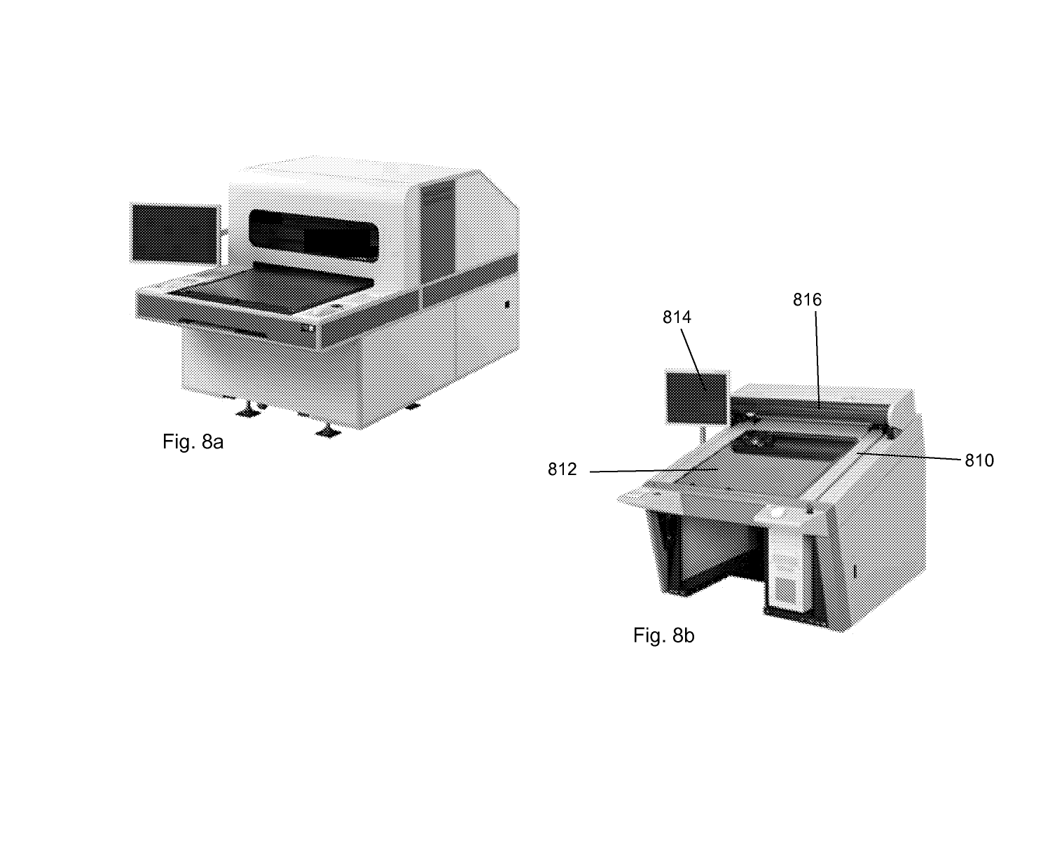

FIGS. 8a and 8b illustrate further embodiments of systems described herein.

FIGS. 1a and 1b illustrate print artefacts in a printed image that may arise due to a variation in the print gap between the printer nozzles and the substrate surface. FIG. 1a illustrates a portion of text 110 printed at a linear speed of 1.4 m/s with a print gap of 1.2 mm. FIG. 1b illustrates a portion of text 112 printed at the same print speed, but with a print gap of 2.5 mm. Satellite drops are evident with the larger print gap, and edge acuity is reduced.

Embodiments of the systems and methods described herein aim to increase the uniformity of the print gap to reduce such artefacts, by measuring the gap variation over the print zone and using this data to “print” a shim of varying thickness.

A UV curing ink jet printer can print a shim of any thickness by building it up in a series of layers, so that the ink is printed and cured in a repeating sequence. The print data is arranged so that the top surface of the shim will present a uniform gap to the printheads. The top surface of the printed shim could be used as the working surface of the printer, but it is preferable to place a thin top sheet on top of the shim to provide the working surface. This top sheet can for instance be 1 mm thick aluminium sheet. The shim can be printed by the printer itself, in-situ, so that the operation may be done at any time, and in particular after installation of the printer in its final working location. This helps to take account of distortion of the chassis.

By measuring the variation on a final machine in situ, the various sources of tolerance stack up for the printhead to substrate support gap are all taken into account.

The top surface of the table for an inkjet printer is usually covered in holes to provide vacuum hold down of the substrate to be printed. The shim can easily be arranged to have matching holes so that the vacuum holes are not blocked. The top sheet also needs to have a series of vacuum holes, so that the substrate to be printed is held down. It is convenient to make the shim as a series of separate “pills”, this allows air flow across and along the table in the gap between the table top surface and the top sheet. The “pills” can be arranged to avoid obstructing vacuum holes in either the table or the top sheet. Keeping the shim as a series of separate “pills” also makes it easier to remove a section of them for repair.

The spacing between areas of shim will depend on the stiffness of the top sheet, if a very flexible top sheet is used then the gaps between shim areas should be small to make sure the top sheet is adequately supported. We have found that a “pill” diameter of 10 mm with a grid spacing of 15 mm works well with an aluminium top sheet of 1 mm thickness.

If the shims are printed as separate areas, it is helpful to print a solid border for the top sheet to reduce air flow from the sides of the table, which would reduce the vacuum hold down.

The shim can either be printed on the table itself, or on the bottom surface of the top sheet. Printing on the bottom of the top sheet has the advantage that if the shims become damaged, it is relatively easy to produce a new top sheet complete with shim. The top sheet may be in several parts, or in a single piece. If printing onto the table, then areas of damaged shims would need to be scraped off before repair.

A particular embodiment of the apparatus described herein is illustrated schematically in FIGS. 2 and 3. FIG. 2 shows an uneven table surface 210 onto which have been printed spacers 212 of varying heights. The height of each printed spacer 212 accommodates the variation in the level of the table surface 210. The printed spacers 212 support a top skin 214 or substrate support surface and maintain the skin 214 level and flat to support the substrate.

FIG. 3 further illustrates that the spacers 212 comprise a plurality of discrete “pills”, to enable air flow underneath the substrate support surface 214 as described above. The substrate support surface 214 also includes vacuum holes 216, which facilitate securing of the substrate to the surface 214. Further vacuum holes are provided (not illustrated) in the table 210, which are connected to a vacuum source.

There may be fewer, but larger, vacuum holes provided in the table 210 than in the support surface 214. The vacuum holes in the table are required simply to enable the vacuum pressure to pass through to the substrate support surface 214. However, the vacuum holes 216 in the substrate support surface 214 may need to hold the substrate more securely to the surface, so a dense array of smaller holes can be advantageous, especially for a flexible substrate.

The process of applying the shim to the printing apparatus will now be described according to one embodiment.

The printing apparatus is first installed, preferably in its ultimate location and the apparatus is physically adjusted to ensure that the printer table is as flat as possible, for example, by adjusting the feet of the printer table. The substrate support surface, in this embodiment comprising a 1 mm thick sheet of aluminium, is placed on the printer table and may be secured into position. The printhead is then mounted on support means, including a printer carriage, over the substrate support surface.

A sensor is mounted next to the printhead on the print carriage. The sensor comprises an inductive sensor, but could be a laser sensor or any other suitable means for measuring the print gap. The sensor is connected to data processing apparatus, such as a computer, to receive, process and store data gathered by the sensor.

The position of the sensor relative to the print area is first calibrated. This may be done simply by using position information from the printing apparatus relating to the position of the printhead to which the sensor is mounted. Alternatively, the position may be determined by using the sensor to detect the position and orientation of an artefact having a known position in the printing area, such as a hole in the substrate support surface.

Once the position of the sensor has been calibrated, the printer carriage is moved across the print area to enable the sensor to scan the whole print area. The sensor determines the print gap, that is the distance to the substrate support surface, over the whole print area and transmits this data to the data processing apparatus. Preferably, the distance is calculated at a dense array of points across the surface to enable variations in the topography to be corrected at small scales.

The data processing apparatus stores information relating to the position of any vacuum holes in the substrate support surface and the printer table. The data processing apparatus uses the measurements from the sensor and the stored data relating to the position of vacuum holes to calculate the necessary height and positions of spacers that can correct for variations in the print gap. A plurality of spacers is designed in a grid pattern in areas of the table where support is necessary. The positioning of the pattern is adjusted to take into account the distance between the sensor and the printer nozzle.

The required spacer pattern is then transmitted to the printer. The printer controls the printer carriage and printhead to build up the spacers to the height calculated by the data processing apparatus by applying a plurality of layers of ink. The ink is preferably UV curable ink, and each layer of the spacer is cured by UV radiation when it has been applied.

In this embodiment, the spacers are printed onto the reverse side of the substrate support surface. When the spacers have been printed, the substrate support surface is then turned over so that the spacers are disposed between the printer table and the substrate support surface. This arrangement can mean that, if the printer installation is changed, for example if its location is moved, spacers can be printed onto a new substrate support surface and the printer gap can be made constant again without requiring modifications to the printer table and without requiring spacers to be removed from the printer table.

In a final verification step, the sensor may be scanned over the substrate support surface after its installation on the printer table to ensure that the printed spacers provide the correct support to hold the surface in a planar topography.

In an alternative embodiment, a laser sensor may be used to measure the print gap. In this embodiment, the distance between the printhead and the printer table can be measured directly without the need for a conductive substrate support surface. The sensing and printing steps of the method described above may then be combined into a single step. For example, the print gap may be sensed for one row in the printer area and the printhead may then be activated directly to compensate for variations in the print gap. In this embodiment, the spacers may be printed directly onto the printer table. The substrate support surface may then be laid on top of the printed spacers.

FIG. 4 illustrates a plurality of printed shims on a portion of a printer table according to one embodiment. As illustrated in FIG. 4 the shims are printed as discrete spacers in a grid pattern. Lighter areas of shims 410 comprise shims that are thin, perhaps only a few layers thick. Darker shims 412 are thicker, comprising multiple printed layers. FIG. 4 also illustrates a border 414 printed along the edge of the printer table, which acts as an air dam to prevent loss of vacuum that could be caused by air leaking from underneath the substrate support surface. It is noted that the border 414 also varies in thickness depending on the print gap at that point.

FIGS. 5a and 5b illustrate a printer set-up according to one embodiment. The variations in the print gap and the size of the shims have been exaggerated in the figures for clarity. FIG. 5a illustrates a printer having a printer table 510 with an uneven surface 512. A printhead 518 is mounted on a print carriage 514 and supported on a print axis 516 above the printer table 510. A sensor 520, in this embodiment a laser sensor, is mounted on the print carriage 514 next to the printhead 518. In the sensing mode, illustrated in FIG. 5a, the sensor 520 is passed over the printer table surface 512 and is used to measure the print gap between the printhead 518 and the table surface 512. The print axis 516 is not straight.

The measurements are stored and used, as described above, to print a plurality of shims 524 in a grid pattern on the lower surface of a substrate support surface 522, as illustrated schematically in FIG. 5b. In the embodiment illustrated in FIG. 5b, the sensor 520 is removed from the print carriage 514 once the shims 524 have been printed.

As described above, the methods and systems described herein may be used in conjunction with a variety of different systems, some of which are described in more detail below. In addition to the specific examples below, the skilled person will appreciate that the techniques described can be used in a wide range of technology areas in which accurate conformity of a support surface to a required topology is advantageous. In particular, techniques described herein can be used to decrease variations of a work surface from a planar topography.

In any of the embodiments described herein, the printed shim may be laid down in a plurality of successively thinner layers. This may enable a thicker layer to be laid down initially, to provide quickly an approximation to the desired topography. Subsequent, thinner layers may then be laid down, at least in certain areas of the shim, to achieve a higher accuracy in the topography of the shim.

Slit Coater

An important step in the manufacture of flat panel displays (FPDs), such as LED, LCD or plasma screens, is the application of a “resist” layer onto a substrate such as glass.

The resist layer can be laid onto the substrate using a slit coater, which can include a slit of around 2 m in length. The resist layer may then be processed, for example by exposing the layer to a laser, as described in more detail below. One example of a resist layer may be an active material for an organic LED.

The substrate onto which the resist layer is deposited is generally much larger than a single FPD. For example, a glass substrate of around 5 m² or larger may be processed and coated before being cut into several pieces to form separate FPD screens.

FIG. 6 illustrates a slit coater according to one embodiment, which comprises a work piece support surface 610 onto which is placed a substrate 612 such as a plate of glass. A slit coater 614 is moved over the substrate 612 in order to deposit a thin layer of resist material 616 onto the substrate 612.

As will be appreciated by the skilled person, the thickness of the coating deposited by the slit coater 614 is dependent on the gap between the slit and the substrate 612, which will in turn be affected by any variations in the height of the support surface 610. The typical desired thickness for the coating can be from around 0.1 micrometers to around 10 micrometers.

The techniques described herein can be used to print a shim layer to minimise variations in the gap between the slit 614 and the substrate 612. In addition, the shim layer can be printed to take into account that the slit may not be precisely straight, which may itself lead to variations in the thickness of the coated resist layer.

In order to determine the thickness of the shim layer that is needed at various points over the support surface, a test resist layer may first be printed onto a substrate. Variations in the thickness of the test layer can then be used to determine the “correction” needed at each point to ensure an even coating of the resist layer and the shim may then be printed accordingly.

The shim layer may be printed in accordance with any of the methods described above. The skilled person will also appreciate that these techniques may be applied to any apparatus in which a slit coater is used to apply a uniform layer of material to a substrate.

A further example may be the application of a colour filter to a substrate in which it is highly desirable to apply an even layer of coloured material to a substrate to ensure uniformity of the colour for the filter.

Photo-Resist Lasering

In a further embodiment, which follows on from the embodiment illustrated in FIG. 6, a laser may be applied to a resist layer that has been laid down onto a substrate. The lasering step may selectively “fix” the resist layer. Areas of the layer that have not been fixed by the laser (or, alternatively areas that have been exposed to the laser) may subsequently be removed from the substrate, for example by washing, to leave behind resist material only in desired areas or in a desired pattern.

FIG. 7 is a schematic diagram of a photo-resist lasering system according to the present embodiment. A support surface 718 has had a shim layer 714 printed onto it in the form of a plurality of spacers arranged in a grid pattern. The roughness of the support surface 718 has been greatly exaggerated for the purposes of illustration. The shim layer is covered by a further support surface 712 onto which the FPD 716 covered in the resist material is placed. The shim layer 714 is arranged so that a laser module 710 is mounted at a constant distance from the FPD 716 as the laser is moved over the surface of the FPD.

Although the laser contained within the laser module 710 can be a variable focus laser, as described above, minimizing variations in the distance from the FPD to the laser can reduce the amount of refocusing required at the laser. This can increase the accuracy of lasering and increase the speed at which the lasering can be implemented. Further, once the shim has been arranged to minimise variations in the distance between the FPD and the laser, it may reduce the necessity to measure the distance to the FPD as the laser moves over the surface, since the need for constant measuring and refocusing of the laser can be reduced.

PCB Inspection and Repair

In a further embodiment, the methods and techniques described herein may also be used in the field of inspection and repair of Printed Circuit Boards (PCBs). Examples of apparatus in which the present techniques may be implemented are illustrated in FIGS. 8a and 8b.

A PCB support surface 810 provided onto which may be placed a PCB 812 for inspection and/or repair. An imaging device, such as a line scan camera 816 can be used to provide a high resolution image of the PCB which can then be displayed on a screen 814. A printed shim layer may be used under or on top of the support surface 810 to support the PCB 812 at a constant distance from the imaging device 816. It is noted that the PCB may be supported in a horizontal configuration as illustrated in FIG. 8a or at an angle from the horizontal, which may be more convenient for the operator. The apparatus may include a device for repairing defects in PCBs, in addition to or in place of the imaging device.

Systems such as those illustrated in FIGS. 8a and 8b may allow inspection and repair of ultra-high-precision PCBs, such as those with line and space patterns down to around 7.5 micrometers.

The imaging device may comprise a telecentric optical system with both coaxial download and ring-type diffused illumination to allow ultra-fine lines to be captured with precision.

As will be appreciated by the skilled person, the addition of a shim layer to minimise variations in the distance between the imaging or repair devices and the PCB can reduce the focussing required by the imaging system, thus increasing the speed and accuracy of imaging, and increase the accuracy of repairs.

It is further noted that, for a printed or lasered PCB, a table comprising a shim layer as described herein may also be used to maintain a constant distance between the PCB and the printhead or laser. This may increase the accuracy of the PCB, thus reducing the need for later inspection and repair of PCBs.

Line Measurement for FPDs

In a further embodiment, the systems and methods described herein may be used for line measurement of FPDs. As FPDs increase in size and definition, increased dimension measurement capabilities and accuracy is required of the measuring system used in the manufacture of photomasks.

High-precision apparatus may be provided to measure line-widths of photomasks for LCD panels, color filters, printed circuit boards, etc., and the line widths of resist patterns for LCD panels. The line widths being measured may have a repeatability of around 10 nanometers over areas of around 2 m² or greater. The techniques described herein may be used to provide a work surface having constant distance to the measuring system, which may include a high-resolution optical system.

Thin Film Solar Cells

In another embodiment, the methods and apparatus described herein may also be used in the manufacture and measurement of thin film solar cells. In such systems, a thin layer (from a few nanometers to several micrometers in thickness) of photovoltaic material is deposited on a substrate. To ensure an even deposition of the substrate, a printed shim layer as described above may be useful in providing a constant gap between the substrate and the film deposition apparatus.

After deposition, it can be advantageous to check the thickness of the substrate and identify any errors. Imaging techniques, such as those described above, can also benefit from having the substrate supported at a constant distance from the imaging device.

It will be understood that the invention described herein may be applied to a large number of other applications not specifically set out in detail herein. For example, the systems and methods described herein may be used to increase the accuracy of nozzle printing of organic LEDs (OLEDs). Similarly, coatings may be applied to OLEDs using the techniques described herein. OLEDs may be used for example in the fields of flat panel displays or lighting displays.

It will be understood that the present invention has been described purely by way of example and modification of detail can be made within the scope of the invention. It will be clear to one skilled in the art that features of one embodiment may be applied to other embodiments. Each feature disclosed in the description and (where appropriate) the claims and drawings may be provided independently or in any appropriate combination.

1. A method of approximating the topography of a work piece support surface for a machine to a required topography, the method comprising:
taking measurements representative of the topography of the surface;
determining the thickness profile of a shim layer to approximate the topography of the surface to the required topography based on the measurements; and
applying the shim layer to the surface;
the shim layer being provided by printing the shim layer from a print head.

2. The method as claimed in claim 1, comprising printing the shim layer directly onto the surface.

3. The method as claimed in claim 1, wherein the shim layer comprises at least one layer of ink.

4. The method as claimed in claim 1, wherein the shim layer comprises a discontinuous layer comprising a plurality of spaced apart portions.

5. The method as claimed in claim 4, wherein the spaced apart portions comprise a plurality of spacers, preferably wherein the spacers are printed in a grid pattern.

6. The method as claimed in claim 1, comprising:
providing an overlayer, and placing the overlayer on the surface to provide a working surface.

7. The method as claimed in claim 6, comprising printing the shim layer onto the overlayer or printing the shim layer between the surface and the overlayer.

8. (canceled)

9. (canceled)

10. The method as claimed in claim 1, in which the required topography is a flat surface, such that the thickness of the shim layer is determined to mitigate variations in the measured topography.

11. The method according to claim 1, in which the measurements representative of the topography of the surface comprise the distance at a plurality of positions between the surface and a reference point.

12. The method according to claim 11, wherein the reference point comprises the location, at each of the plurality of positions, of a sensor mounted over the surface or a workhead mounted over the surface.

13. (canceled)

14. The method as claimed in claim 12, in which the workhead or sensor is mounted for movement over the surface in a plane substantially parallel to the surface.

15. The method as claimed in claim 14, in which the work head is the printhead.

16. The method according to claim 11, wherein the required topography is a topography in which the distance between the reference point and the surface is substantially equal at each of the positions.

17. The method as claimed in claim 1, in which the work head is a machine for applying a coating to the work piece, and the measurement step comprises measuring the thickness of a coating applied by the machine.

18. (canceled)

19. The method as claimed in claim 16, comprising measuring the thickness of a workpiece, and in which the distance corresponds to a focal distance of the work head minus the thickness of the workpiece.

20. The method as claimed in claim 19, in which the work head is a device for inspecting the work piece, a focussed laser or an imaging device.

21. (canceled)

22. (canceled)

23. A machine having a work head and a support surface for a work piece, a printed shim layer being applied to the support surface, the shim layer having a thickness profile arranged to approximate the topography of the surface to a reference topography.

24. The machine as claimed in claim 23, in which the reference topography is a substantially flat surface.

25. The machine as claimed in claim 23, in which the reference topography is such that a gap between the support surface and the work head is substantially constant.

26. A machine for depositing a coating onto a substrate, the machine having a coating head mounted above a substrate support surface and arranged to move over the surface to apply the coating, and a printed shim layer provided between the support surface and the substrate, the shim layer having a thickness arranged to mitigate variations in the gap between the coating head and the substrate so as to maintain a substantially constant coating thickness.

27. (canceled)

28. (canceled)

29. (canceled)
